(19) United States
(12) Patent Application Publication
(10) Pub. No.: US 2002/0073589 A1
(43) Pub. Date: Jun. 20, 2002

(54) Fishing pole test clip and method of identifying test weight of fishing line and date of installation of fishing line

(76) Inventor: Ernest Lee Tate, Jamul, CA (US)

Correspondence Address: ERNEST LEE TATE, 14510 Skyline Truck Trail, P. O. Box 655, Jamul, CA, 91935, US

(21) Appl. No.: 09/742,513

(22) Filed: Dec. 20, 2000

(51) Int. Cl. G09F 3/10; G09F 3/16

(52) U.S. Cl. 40/666; 40/299.01

(57) ABSTRACT

An identifying clip which may be attached to a fishing pole for conveying information regarding the test weight of fishing line and the date of installation of fishing line.

### CROSS-REFERENCE INFORMATION

Portions of this invention were disclosed in Disclosure Document #461067, filed Aug. 24, 1999, a copy of which is attached hereto and which is hereby incorporated by reference.

### BACKGROUND OF THE INVENTION

1. Field of the Invention

The present invention relates generally to fishing and, more specifically, to means for identifying the test weight of the fishing line on a fishing pole and the date the line was installed.

2. Background Information

Identifying tags have been used for many different purposes. A multitude of identification tags used for identification of stethoscopes and other types of devices have been utilized in the past, some being ornamental in nature and some having a unique method of attachment to the devices with which they are utilized. Fishermen have in the past used masking tape taped to the inside surface of the reel with information about the fishing line test weight and date of installation written thereon. Applicant is unaware of any such identification tags utilizing any method or means similar to the present invention for identifying the size or test weight of fishing line and/or the date the fishing line was installed. Applicant is further unaware of any prior art pertinent to and having the utilitarian features of the present invention, especially as they relate to identifying the size or test weight of fishing line and the date installed and how the clip attaches to a fishing pole or reel.

### BRIEF SUMMARY OF THE INVENTION

The present invention is a means and a method of identifying the size or test weight of fishing line on the reel of a fishing pole and the date of installation of that line. The standard of the art appears to be simply attaching masking tape on the inside of the reel with the installation date and test weight of the line written thereon. One of the problems with this method is that is that either the masking tape or simply the information written on the masking tape gets rubbed off and the information is lost. Alternatively, one might put a paper tag held in place by adhesive on the reel or somewhere on the fishing pole, but again, the potential problem is that it simply gets rubbed off, and the tape or the material that is adhered to the pole or reel is lost, along with the information thereon that is necessary to be able to identify the condition of the fishing line.

More specifically, in its preferred embodiment, the present invention consists of a more or less cylindrically shaped clip designed to be placed on the shaft of the handle of the fishing reel or on the fishing pole itself. It could be constructed utilizing a plastic clip, as shown in the attached drawings, designed to be placed on the shaft of the handle of the fishing reel or the fishing pole or rod, but any other sort of material which would be capable of maintaining its position and shape could also be used. Specifically, the present invention consists of a semicylindrical piece of material shaped so as to enable its attachment to the shaft of the handle of the fishing reel or to the fishing pole by simply spreading it and sliding it over the shaft of the handle of the reel or over the pole. The clip just disclosed can be numbered and color-coded so as to identify the test weight and/or age of the fishing line on the reel. The test weight of the fishing line, the color, and/or the date the line was installed can be coded at the factory, and thus the clip can be chosen to match a particular set of circumstances, or it can be scribed with a stylus or other sharp object and/or marked in some other manner with the test weight of the fishing line and a date of installation. This makes it unlikely that such information will be lost unless the clip gets broken. As a result, anglers can maintain quick access to the information directly applicable to a particular fishing pole arrangement, even though the fishing pole and the fishing line may have been in place and stored for one or more years.

One of the objects of the present invention is to provide a means for identifying the test weight and date of installation of fishing line long after the installation of the fishing line.

Another object of the present invention is to provide a method of long-term identification of the test weight of fishing line and the date of installation.

A further object of the present invention is to provide a durable clip which is easily marked and/or color-coded to identify the test line and the date of installation and is very unlikely to be compromised over a long period of time.

The foregoing objects and benefits of the present invention will become clearer through an examination of the drawings, the description of the drawings, the description of the preferred embodiment, the claims, and the abstract which follow.

### BRIEF DESCRIPTION OF THE SEVERAL VIEWS OF THE DRAWINGS

FIG. 1 is a perspective view of a clip of the present invention.

FIG. 2 is a perspective view of the shaft and handle of a fishing reel and rod showing the clip of the present invention in position on the shaft of the reel.

FIG. 3 is a perspective view showing the tab of the present invention in position on the rod of a fishing pole.

FIG. 4 is a perspective view showing the tab of the present invention coded to identify a particular test weight and date of installation of fishing line.

### DESCRIPTION OF THE PREFERRED EMBODIMENT

The present invention includes a means and a method for identifying over a long period of time the test weight of fishing line and the date the fishing line was installed on the reel of a fishing rod. This results in less loss of fish due to old or inadequate test weight fishing line and fewer problems for an angler when he goes fishing after his pole has been stored for a period of time. A consideration of the drawings taken together as a whole will make clearer both the means—that is, a clip utilized for conveying information about the test weight and date of installation of fishing line—and the method of identifying the test weight and date of installation of the fishing line as well.

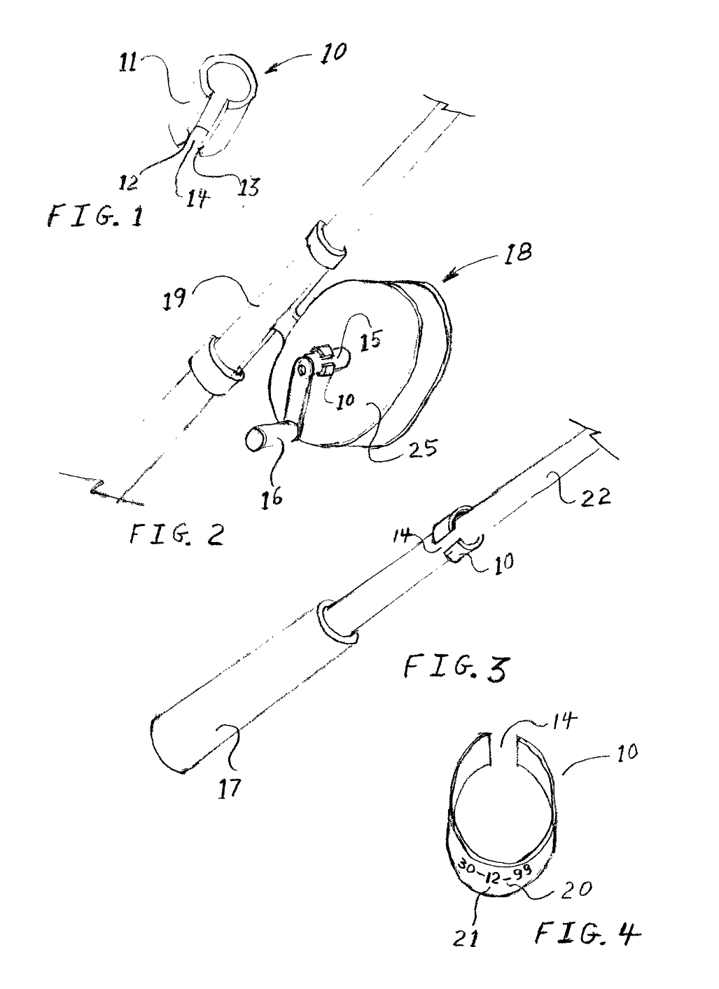

Going now to FIG. 1 of the drawings, the clip 10 of the present invention is shown. The body 11 of clip 10 is semicircular in nature, having ends 12 and 13 and a slot therebetween so that, when ends 12 and 13 are pulled apart, the body 11 of clip 10 can be slid over the shaft of a fishing reel such as fishing reel 18 in FIG. 2 of the drawings or over the fishing rod as shown in FIG. 3 of the drawings.

As shown in FIG. 2 of the drawings, clip 10 may be positioned on shaft 15 between handle 16 and body 25 of reel 18, making it easy to read and very visible.

In FIG. 3, clip 10 is shown positioned on shaft 21 of fishing pole 19. Because most rods have a varying diameter, clip 10 may be slid onto rod 22 until tight to securely position it thereon. Alternatively, clip 10 can also be held in position by rubber cement or any other adhesive as desired.

FIG. 4 shows the means of identifying the test weight of the fishing line and the date of installation of the fishing line on the particular reel or fishing pole. The first designation 30 in this situation indicates the test weight of the line installed. The second and third designations indicate the month and year of installation. Tabs of different colors can be used so as to identify fishing lines of particular test weights, or a generic-type tab on which the information is scribed or etched or otherwise placed as shown in FIG. 4 might be utilized in implementing the present invention.

The means of identifying the test weight of the fishing line and the date installed consist substantially of the use of a tab having the features just disclosed. The method of identifying the test weight of the line and date installed includes the positioning of a premanufactured clip which includes means for carrying the identifying information.

While the foregoing description of the preferred embodiment of the present invention has disclosed specific constructions, means and methods of accomplishing the present invention, because specific improvements and modifications will become readily apparent to those skilled in the art of fishing poles, rods and reels and the like, it is applicant's intent not to be limited by any of the foregoing descriptions, but only by the claims which follow.

I claim:

1. Identification means for providing information about fishing line installed on a fishing reel;
means for adhering the identification means to a fishing reel;

2. The invention of claim 1 wherein the identification means comprises a clip which can be securely positioned on the fishing reel.

3. The invention of claim 1 wherein the identification means is color-coded to convey information about the fishing line.

4. The invention of claim 1 wherein the identification means includes material upon which identifying information can be placed.

5. Identification means for providing information about fishing line installed on a fishing rod;
means for adhering the identification means to a fishing reel;

6. The invention of claim 5 wherein the identification means comprises a clip which can be securely positioned on the fishing rod.

7. The invention of claim 5 wherein the identification means is color-coded to convey information about the fishing line.

8. The invention of claim 5 wherein the identification means includes material upon which identifying information can be placed.
